(19) United States
(12) Patent Application Publication
(10) Pub. No.: US 2024/0043081 A1
(43) Pub. Date: Feb. 8, 2024

(54) PIVOT BRIDGE UNIT FOR CONNECTING A BICYCLE SADDLE TO A SADDLE SUPPORT

(71) Applicant: Detlef GNEUSS, Carabietta (CH)

(72) Inventor: Detlef GNEUSS, Carabietta (CH)

(21) Appl. No.: 18/229,713

(22) Filed: Aug. 3, 2023

(30) Foreign Application Priority Data
Aug. 5, 2022 (DE) 10 2022 119 796.4

(51) Int. Cl. B62J 1/08; B62J 1/04

(52) U.S. Cl. CPC B62J 1/08; B62J 1/04

(57) ABSTRACT

A pivot bridge unit to connect a bicycle saddle to a saddle support, the bicycle saddle including a seat element having a seat surface and at least two fastening rods spaced a distance apart on an underside of the seat element. The pivot bridge unit having a pivot axis extending in a longitudinal direction of the seat element. A central base, which is connectable to a saddle support head, includes at least one bearing for the pivot axis. A saddle clamping element, which is supported on the pivot axis, is designed to hold the fastening rods of the seat element. At least one compressible damping element supporting the saddle clamping element with respect to the central base, an axis of the at least one compressible damping element is pitched at an angle of 5° to 30° in relation to a vertical center line.

This nonprovisional application claims priority under 35 U.S.C. § 119(a) to German Patent Application No. 10 2022 119 796.4, which was filed in Germany on Aug. 5, 2022, and which is herein incorporated by reference.

### BACKGROUND OF THE INVENTION

### Field of the Invention

The present invention relates to a pivot bridge unit for connecting a bicycle saddle to a saddle support, the bicycle saddle including a seat element having a seat surface and at least two fastening rods, spaced a distance apart, on its underside, and the pivot bridge unit at least comprising: a pivot axis extending in the longitudinal direction of the seat element; a central base, which is connectable to a saddle support head and which includes at least one bearing for the pivot axis; and a saddle clamping element, which is supported on the pivot axis and is designed to hold the fastening rods of the seat element.

### Description of the Background Art

The saddle of a bicycle is a central point for applying force to the pedals. The cyclist's bones, cartilage, nerves, muscles, etc. are connected to each other in the area of contact with the saddle. This point should generally be stable. A loose connection between the saddle, and the bicycle or also a loose seating of the rider on the saddle, results in an irritation of the movements. It is likewise not beneficial when applying force to the pedals, which also varies significantly along with the angle at the knee. The maximum application of force to the pedals is made possible when a leg is almost extended, so that this is also significant during sports cycling. When the leg extends, the inner thigh area slides sideways from the saddle, so that a greater pressure to the tissue occurs at this location, in particular in the uppermost inner area of the thigh in the groin region. In the case of simultaneous, constant movement, the pressure results in rubbing between the saddle and the skin.

Eliminating the pressure load with a soft saddle is achievable only to a very limited extent, and this tends to be a hindrance in sports cycling, since the seat stability is lost thereby.

Bicycle saddles are known, in which a pivot axis exists which extends lengthwise in the direction of travel and which permits lateral tilting of the saddle. A saddle is described in patent application DE 405 358 A, which has a pivot axis of this type. However, a linear displacement of the saddle in the direction of travel should also be possible at the same time. A complex guidance is necessary to simultaneously permit tilting and longitudinal displacement.

A further laterally tilting saddle is illustrated in DE 1 231 126 B. A bearing for a so-called balance beam is provided here, which is intended to permit a pivoting movement of the saddle part to the side. A joint is also provided to allow the saddle to tilt toward the rear around a horizontal axis running transversely to the direction of travel. The saddle upper part is supported against a base via a total of four spiral compression springs. This construction is complex and not suitable for narrow saddles for sports bicycles.

It is also mentioned in DE 40 05 566 A1 that lateral tilting movements should be made possible in a bicycle saddle. The approach also provides for cable hoists in an equally unusual and complex manner for the purpose of controlling the movement.

The older utility model specification DE 202 12 353 U1 provides for a ball head connection of the saddle to the saddle tube, so that tilting movements as well as those to the side are possible.

DE 697 20 497 T2, which corresponds to U.S. Pat. No. 6,152,524, describes a further variant of a bicycle saddle, which is intended to permit lateral pivoting movements around an axis, which extends in the longitudinal direction of the bicycle. This axis is situated far up to the right, namely directly in the area of the seat surface.

The bicycle saddle according to DE 20 2014 010 041 A1 also provides for a pivot axis in the longitudinal direction. The lateral tilting movement is damped by air spring elements.

No longitudinal axis is provided in the bicycle saddle according to the European patent EP 2 003 046 B1. However, a lateral tilting movement is made possible in that a seat element is fastened via a punctiform, elastomeric element on the saddle tube. The tilting angle is limited by further elastomeric elements.

A compact approach is described in DE 20 2017 001 074 U1 in the form of a pivot bridge unit, which is insertable between a conventional saddle support and a conventional seat element of a bicycle saddle, so that existing parts may be used. The pivotable unit is held by two torsion springs. The restoring forces active during a side inclination are determined only by the properties of the torsion springs used and may therefore be changed only by replacing the torsion springs.

### SUMMARY OF THE INVENTION

It is therefore an object of the present invention to permit a limited side inclination and thereby increase comfort in a bicycle saddle of the type mentioned at the outset.

This object is achieved by a pivot bridge unit for a bicycle saddle. The pivot bridge unit according to the invention has the advantage, in particular, that a damped side inclination movement is achievable by at least one damping element on each side, which may possibly be pretensioned.

The sensitivity of the two side damping elements may be easily adjusted, due to an optional ability to pretension them.

The term “damping element” within the meaning of the invention can be understood to be a shock-absorbing and pivoting movement-damping element, it being a deformable and restorable spring element in the physical sense, which is combined with an additional kinetic energy-consuming element, i.e., a damping element in the physical sense.

For an optimal functioning of the pivot bridge unit, it is particularly advantageous if the damping element is selected and designed in such a way that the damping starts out very gently at the beginning of the lateral pivoting movement of the pivot bridge and if as little breakaway torque as possible is present.

Damping elements made from elastomers or rubber are highly suitable for this purpose. Elastomeric, compressible damping elements are therefore preferably used, which are available at low cost and which damp and limit the lateral pivoting movement in a manner pleasant for the cyclist.

Spiral compression springs or disk springs which have a low installation height may also be used as the damping element within the meaning of the invention.

Spiral compression springs or disk springs should be provided with a two-layer or multilayer design to achieve the effect described above of a gentle damping starting at the beginning of the pivoting movement without breakaway torque. In other words, at least two spiral compression springs or disk springs are connected in series on each side of the pivot bridge unit, i.e., in particular arranged one above the other as a packet, so that the softer spring is active first and only after the total compression thereof is the stiffer spring compressed.

Torsion bar springs are also conceivable for this purpose. it is preferably provided that the pivot point of the pivot axis is positioned between the seat element and the saddle support in such a way that the pivot axis runs in the area of the saddle fastening rods of the seat element, the vertical distance to the saddle fastening rods being variable between 1 mm and 50 mm. The seat surface tilts away to the side by approximately 3 to 10 mm, in particular, with a radius of approximately 2 to 5 cm. it is then held in a form-fitting manner by contact between the saddle clamping element and the central base or by maximum compression of the damping elements.

The pivot axis can be particularly preferably positioned without clearance, i.e., at the exact height of the saddle fastening rods.

The pivoting range of the saddle surface has proven to be an essential criterion in practice, since too great a pivoting movement of the seat surface is felt as being negative. Positive experience has been gained by positioning the pivot axis at a distance of up to 10 mm from the saddle fastening rods. The friction forces between the saddle and the crotch are significantly reduced thereby, so that sensitive body tissue in this region is noticeably protected. An irritation during the transmission of force to the pedals was not identifiable.

The pivot axis is part of a pivot bridge unit, via which the saddle support and the seat element are detachably connected to each other by the fastening rods thereof. The seat element may be designed in the conventional manner, with the integrated fastening rods of the seat element on the underside, and does not require adaptations specific to the invention. Despite the integration of the pivot axis, which permits the lateral inclination, the pivot bridge unit is provided with a compact design and has a low installation height.

An example provides a pivot bridge unit including a central base, which has a semicylindrical projection on the underside as well as a trough-shaped receptacle therefore on the saddle support head. The inclination of the seat element in relation to the saddle tube may be steplessly varied thereby. The set position is held in that at least two screws pull the pivot bridge unit onto the saddle support head.

To limit the lateral inclination and effectuate the return of the seat element to the initial position, at least one damping element is provided on each side in the case of the pivot bridge unit according to the invention.

A pair of damping elements can be provided on each side, upper damping elements can be arranged in each case between the saddle clamping element and the central base, and lower damping elements being provided below the central base, which are connected to the saddle clamping element by screws. During the inclination to the side, the particular upper damping element on the side is compressed thereby and relieves the lower one. On the other side, the upper damping element is simultaneously relieved, and the lower damping element is compressed by the screw.

The spring constants of the upper and lower damping elements do not necessarily have to be the same, and the length of the damping elements may also be different from each other. A stepped suspension is made possible hereby. For example, the upper damping element may be provided with a soft design, so that only a slight resistance is to be felt at the beginning of the tilting movement to the side. As the inclination increases, the damping element on the other side of the center line in each case then becomes increasingly tighter by means of the screw. Since the paths of the tilting seat element on both sides are equal, due to the symmetrical arrangement, the overall characteristics of the spring action are determined by the physical laws applicable to the springs connected in parallel.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a side view of a bicycle saddle, including a pivot bridge unit according to an example of the invention;

FIG. 2 shows a perspective view of the pivot bridge unit;

FIG. 3 shows a perspective view of the central base of the pivot bridge unit;

FIG. 4 shows a rear view of the bicycle saddle, including the pivot bridge unit;

FIG. 5 shows an enlarged detail of the rear view according to FIG. 4;

FIG. 6 shows the rear view according to FIG. 4 in section;

FIG. 7 shows the bicycle saddle, including the pivot bridge unit, in an oblique perspective view from the front;

FIG. 8 shows a perspective exploded view of a bicycle saddle, including a pivot bridge unit, according to an example; and

FIG. 9 shows a cross section of bicycle saddle 100 according to FIG. 8.

### DETAILED DESCRIPTION

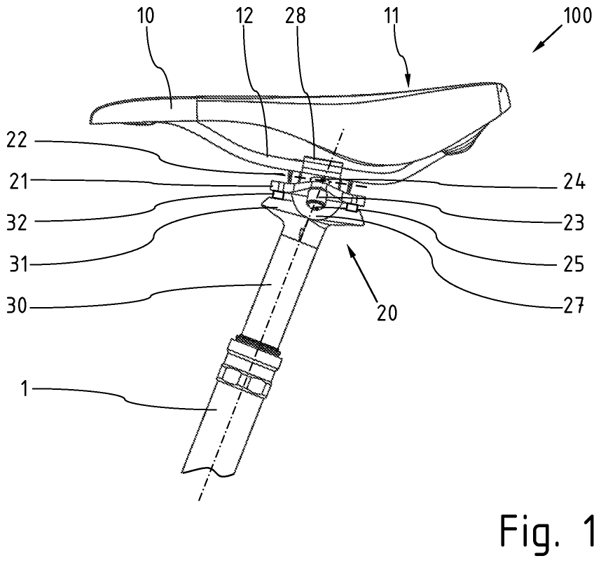

FIG. 1 shows a side view of a bicycle saddle 100. An upper unit of bicycle saddle 100 is formed by a seat element 10, which is formed, for example, an a manner known per se as a plastic shell with a padding mounted thereon. Two fastening rods 12 are integrated into the plastic shell of seat element 10, which run in parallel to each other at least in the area provided for the connection to a saddle support 30. The upper side of seat element 10 forms a seat surface 11.

Saddle support 30 is guided in a saddle tube 1, which may be either a frame component of the bicycle or, for example, a telescopic saddle tube, which is adjustable in length via an integrated hydraulic unit to be able to individually adjust the height of seat surface 11 with respect to the bicycle, possibly even while riding.

Saddle support 30 is designed as a cylindrical tube and ends in a saddle support head 31 on its upper side. In the illustrated example, saddle support head 31 has a trough-shaped indentation on its upper side 31, in which a semicylindrical projection 27 of a pivot bridge unit 20 is supported. The inclination of central base 21 with respect to saddle support 30 may be varied and held continuously via a screw, which extends from a front point on saddle support head 31 or from a rear point into a threaded bore in a central base 21 of a pivot bridge unit 20.

Pivot bridge unit 20 has a two-part saddle clamping element 28 on its upper side, to which fastening rods 12 of seat element 10 are guided and clamped. Saddle clamping element 28 is supported on central base 21 in an articulated manner via a pivot axis 22 extending in the longitudinal direction of bicycle saddle 100.

Saddle clamping element 28 and central base 21 are each supported by damping elements 23, 24 on both sides of bicycle saddle 100, which are held and possibly adjustable by pretensioning screws 25.

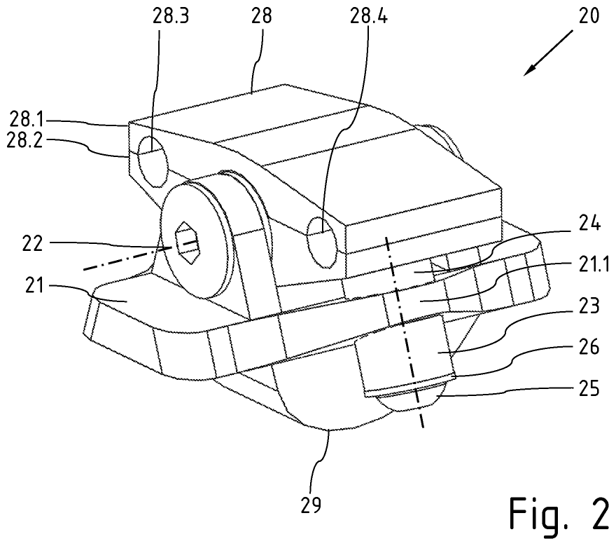

FIG. 2 shows a perspective representation of pivot bridge unit 20 within the other parts of the bicycle saddle. Saddle clamping element 28 is made up of two interconnected half-elements 28.1, 28.2. Grooves in the two half-elements 28.1, 28.2, which open in the direction of the shared contact plane, complement each other in the mounted state of saddle clamping element 28 to form two continuous bores 28.3, 28.4, oriented in parallel, in which fastening rods 12 of seat element 10 are accommodated and clamped. The clamping of fastening rods 12 is released by loosening the connection between half-elements 28.1, 28.2, so that the longitudinal position of seat element 10 is variable with respect to saddle tube 30 and thus to the bicycle frame.

The design according to the invention of pivot bridge unit 20 provides, in particular, for a pivot axis 22, via which saddle clamping element 28 is connected to central base 21 in an articulated manner. To limit the pivoting range and thus to limit the lateral inclination of the seat element in relation to the saddle support, saddle clamping element 28 is supported directly on central base 21 via at least one damping element 24 in each case on both sides of pivot axis 22.

In the illustrated example of pivot bridge unit 20, the invention provides for a further damping element 23 in each case on both sides, which extends downwardly from central base 21. It is oriented collinearly with upper damping element 24. The two damping elements 23, 24 each have a central bore, through which a screw 25 is guided, which engages with lower half-element 28.2 of saddle clamping element 28 from below. An annular washer 26 is provided between the head of screw 25 and lower damping element 24.

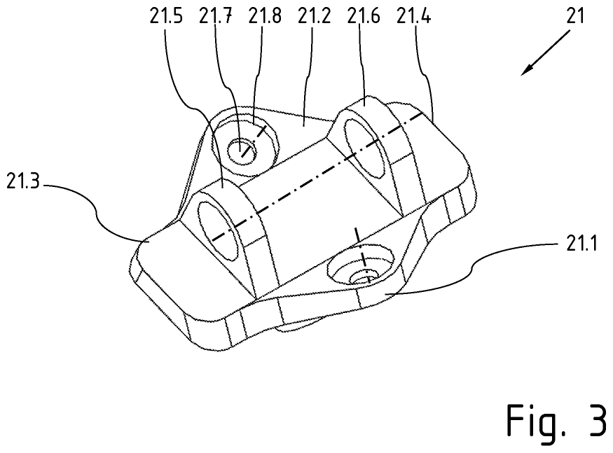

FIG. 3 shows a perspective view of central base 21 of pivot bridge unit 20 as an individual part. Projections 21.3, 21.4 are provided at the front and rear in the longitudinal direction of the saddle, threaded bores being provided on the underside thereof, with which the screws supported on the saddle support head engage. Bearing eyes 21.5, 21.6 accommodate the pivot axis. Upwardly inclined wings 21.1, 21.2 are formed on the sides, which have bores 21.7, around each of which depressions 21.8 are provided on the upper side and lower side of wings 21.1, 21.2, for the purpose of holding and guiding the end of damping elements in a form-fitting manner.

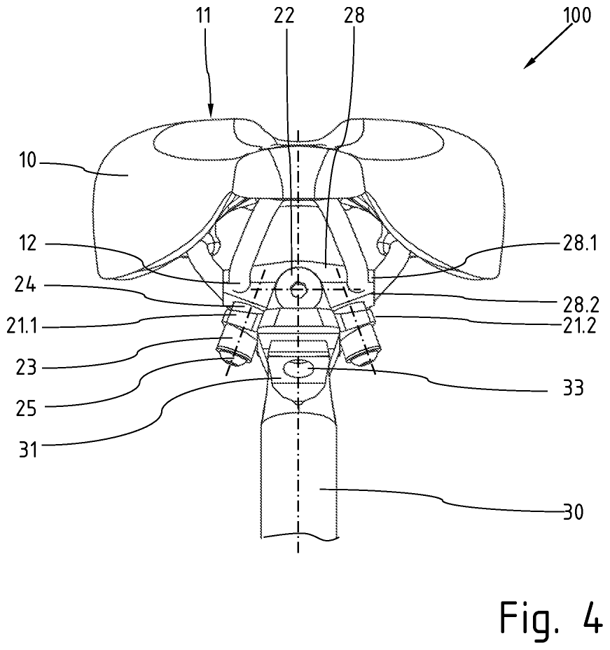

FIG. 4 is a rear view of the bicycle saddle, in particular the inclination of damping element 23, 24 arranged on the side in relation to the vertical center line of bicycle saddle 100 being clarified. In order for damping elements 23, 24 to be compressed in the direction of their particular center line and not obliquely thereto, the underside of half-element 28.2 of saddle clamping element 28 is provided with beveled surfaces on the underside. Since upwardly inclined wings 21.1, 21.2 are each formed on central base 21 at the same time, packets of damping elements 23, 24 are situated obliquely in relation to the center line of saddle tube 30 at an angle of up to 30°.

The position of pivot axis 22 is also apparent in FIG. 4, which is situated with its pivot point only a few millimeters below the contact plane between half-elements 28.1, 28.2.

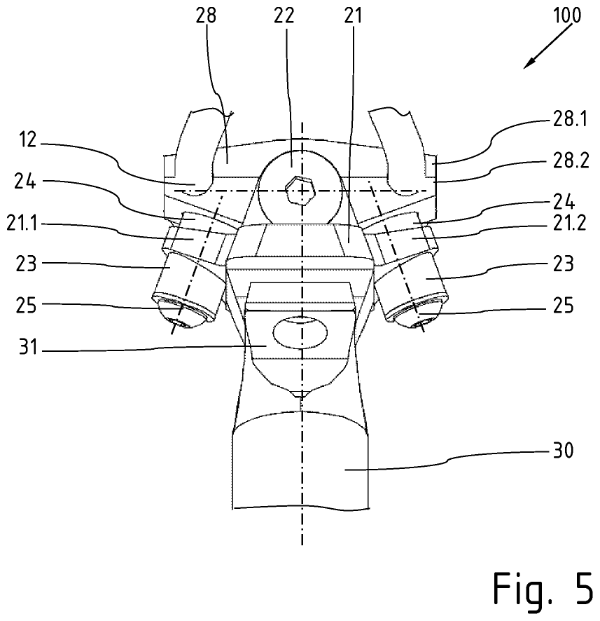

FIG. 5 is an enlarged detail of the rear view of the bicycle saddle according to FIG. 4, damping element 23, 24 being explained on the basis of the position and function thereof. Upper damping element 24 is guided by its upper edge in a cylindrical depression in half-element 28.2. It is accommodated in the depression on the upper side of wing 21.1 of center base 21 by its lower edge, so that damping element 24 is secured against slipping or tilting to the side. A screw 25 is supported by an annular washer 26 on the underside of damping element 23 and extends through lower damping element 23, wing 21.1, upper damping element 24, and lower half-element 28.2 up to upper half-element 28.1 of saddle clamping element 28, in which a threaded bore is formed, with which screw 25 engages. The two screws 25 provided on the right and left of pivot bridge unit 20 are thus used to connect half-elements 28.1, 28.2 to each other.

For example, if saddle clamping element 28 inclines to the left around pivot axis 22, this results in the compression of upper left damping element 24 between lower half-element 28.2 and wing 21.1 of central base 21. At the same time, screw 25 is pushed out downwardly relative to wing 21.1, so that lower damping element 23 is relieved. On the right side, however, upper damping element 24 is relieved during the same tilting movement of seat element 10 to the left, while lower damping element 23 on the right side is compressed.

As a result, the spring action during the inclination to the left is determined by a superimposition of the properties of upper left damping element 23 and lower right damping element 24. The four damping elements 23, 24 are alternately compressed or relieved crosswise on both sides of the center line of bicycle saddle 100.

A pretensioning may be applied to the packet of damping elements 23, 24 by screws 25. However, it is also possible to screw in fastening screws 25 only far enough to avoid a clearance of damping element 23, 24 with respect to central base 21 or saddle clamping element 28, damping elements 23, 24, however, not being pretensioned.

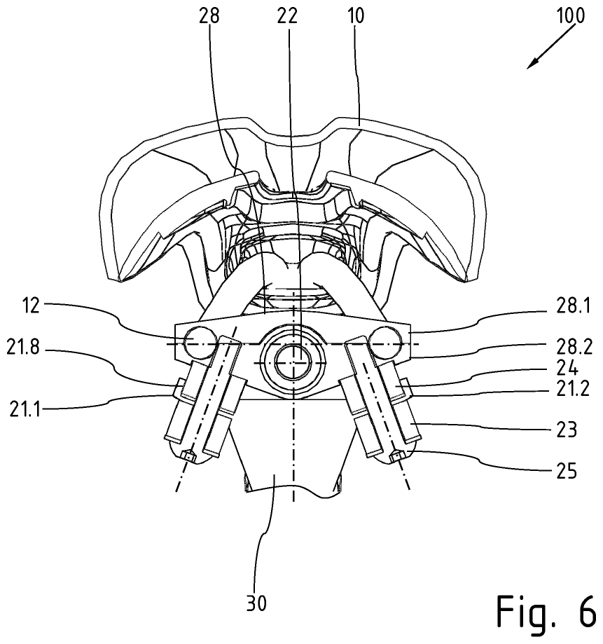

FIG. 6 is a cross section of bicycle saddle 100 in the plane of the center lines of damping element 23, 24. In particular, the receptacle of damping elements 24 in depressions 21.8 on wings 21.1, 21.2 and on the underside of half-element 28.2 is apparent here.

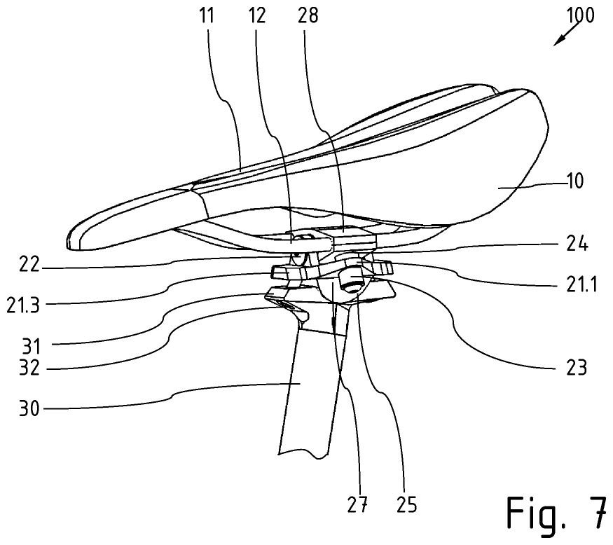

FIG. 7 shows bicycle saddle 100 in a perspective view from the left front. The position of pivot axis 22 between fastening rods 12 of seat element 10 is clear, as is the support of pivot bridge unit 20 via semicylindrical projection 27, which is supported in a hollow in saddle support head 31 extending transversely to the direction of travel and is pulled thereinto and fixed by fastening screws 32. Screws 25 extend downwardly at an angle with lower damping elements 23, so that they are easily accessible, for example, to adjust the spring pretensioning but do not project to the side over seat surface 11 of seat element 10, so that a contact with the insides of the thigh is avoided.

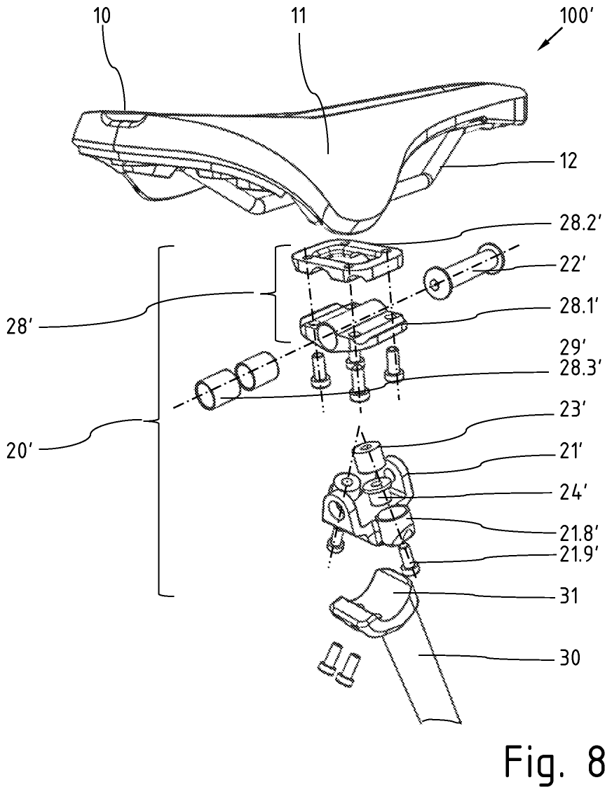

FIG. 8 shows a further bicycle saddle 100′, including a slightly modified pivot bridge unit 20′.

Pivot bridge unit 20′ likewise has a two-part saddle clamping element 28′, which is supported on a central base 21′ in an articulated manner via a pivot axis 22′ extending in the longitudinal direction of bicycle saddle 100′. It is made up of two interconnected half-elements 28.1′, 28.2′, between which fastening rods 12 of seat element 10 are accommodated and clamped.

Instead of the lateral wings provided in the first example, central base 21′ in this case has a cup-shaped, cylindrical receptacle 21.8′ on each side, into which a pressure bushing 24′ is first inserted, onto which a cylindrical, elastomeric damping element 23′ is placed. Pressure bushing 24′ and damping element 23′ are movable within receptacle 21.8′. The cylindrical shape of receptacle 21.8′ limits the radial extension of damping element 23′ guided therein and compressed under load.

Pressure bushing 24′ and damping element 23′ each have a central bore, through which a screw is guided. The screw is used to pretension damping element 23′ inserted between pressure bushing 24′ and saddle clamping element 28′ and to thereby adjust the stiffness.

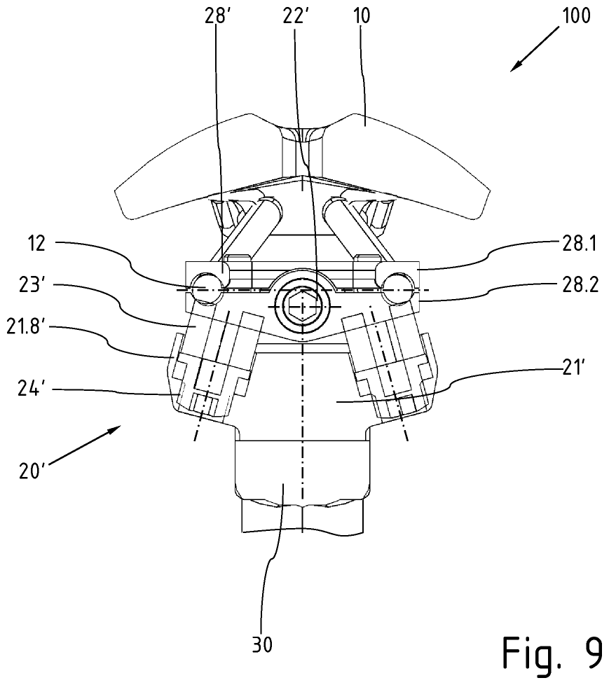

FIG. 9 is once again a cross section of bicycle saddle 100′ in the plane of the center lines of damping elements 23′, so that the accommodation of damping elements 23′ in receptacles 21.8′ on central base 21′ and pressure bushings 24′ inserted below damping elements 23′ in each case are apparent.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A pivot bridge unit to connect a bicycle saddle to a saddle support, the bicycle saddle including a seat element having a seat surface and at least two fastening rods spaced a distance apart on an underside of the seat element, the pivot bridge unit comprising:
a pivot axis extending in a longitudinal direction of the seat element;
a central base, which is connectable to a saddle support head, and which includes at least one bearing for the pivot axis;
a saddle clamping element, which is supported on the pivot axis and is designed to hold the fastening rods of the seat element; and
at least one compressible damping element supporting the saddle clamping element with respect to the central base, an axis of the at least one compressible damping element being pitched at an angle of 5° to 30° in relation to a vertical center line.

2. The pivot bridge unit according to claim 1, wherein the pivot point of the pivot axis is positioned between the seat element and the saddle support such that the pivot axis runs at a height of the fastening rods or no more than 50 mm below the fastening rods of the seat element.

3. The pivot bridge unit according to claim 1, wherein the pivot point of the pivot axis is arranged above the fastening rods.

4. The pivot bridge unit according to claim 1, wherein the pivot axis is part of the saddle clamping element, via which the saddle support and the seat element are detachably connected to each other by the fastening rods.

5. The pivot bridge unit according to claim 1, further comprising a central base, which has a wing pitched upwardly at an oblique angle on each side, on which the at least one damping element is supported.

6. The pivot bridge unit according to claim 1, wherein a pair of damping elements is provided on each side of the pivot axis, wherein upper damping elements are arranged between the saddle clamping element and the central base, and lower damping elements are arranged below the central base, which is connected to the saddle clamping element by screws.

7. The pivot bridge unit according to claim 1, wherein at least one pair of damping elements is designed as elastomeric elements made from elastomeric plastics or rubber.

8. The pivot bridge unit according to claim 7, wherein the elastomeric damping elements are accommodated in cup-shaped receptacles on the central base and are clamped between a pressure bushing inserted into the receptacle and the saddle clamping element.

9. The pivot bridge unit according to claim 1, wherein at least one pair of damping elements is designed as spiral compression springs or disk springs.

10. The pivot bridge unit according to claim 9, wherein at least one pair of damping elements is designed as a two-layer or multilayer combination of spiral compression springs and/or disk springs.

11. A bicycle saddle comprising:
a seat element having a seat surface, which has at least two fastening rods spaced a distance apart on an underside of the seat element;
a saddle support, which has a saddle support head on an upper end; and
a pivot bridge unit according to claim 1.

12. The bicycle saddle according to claim 11, wherein the pivot bridge unit includes a central base, which has a semicylindrical projection on its underside, and wherein the saddle support head has a trough-shaped receptacle therefor.
